(19) United States
(12) Patent Application Publication
(10) Pub. No.: US 2025/0372750 A1
(43) Pub. Date: Dec. 4, 2025

(54) ELECTRIC VEHICLE HAVING BATTERY THERMAL RUNAWAY SUPPRESSION SYSTEM

(71) Applicant: FCA US LLC, Auburn Hills, MI (US)

(72) Inventor: Jill M Koepfer, Petersburg, MI (US)

(21) Appl. No.: 18/675,556

(22) Filed: May 28, 2024

(51) Int. Cl. H01M 10/613; A62C 5/02; A62C 37/48; H01M 10/48; H01M 10/625; H01M 10/63; H01M 10/6552; H01M 10/6567; H01M 50/682

(52) U.S. Cl. CPC H01M 10/613; A62C 5/02; A62C 37/48; H01M 10/486; H01M 10/625; H01M 10/63; H01M 10/6552; H01M 10/6567; H01M 50/682; H01M 2200/10

(57) ABSTRACT

A battery pack thermal runaway suppression system positioned in a battery pack and including a bladder located proximate a plurality of battery cells that contains a fire-retardant material, a plurality of first blades configured to pierce the bladder to release the fire-retardant material within the housing, a plurality of second blades configured to pierce at least one of the coolant inlet line, heat sink, and coolant outlet line to release the coolant within the housing, and a plurality of actuation devices that are configured to actuate the plurality of first blades and plurality of second blades.

### FIELD

The present disclosure relates to an electric vehicle having a battery thermal runaway suppression system.

### BACKGROUND

This section provides background information related to the present disclosure which is not necessarily prior art.

Vehicles with electric propulsion systems are becoming increasingly more common. Some electrically propelled vehicles include an electric drive motor at each wheel of the vehicle, and some electrically propelled vehicles include a front electric drive motor for rotating the front wheels of the vehicle and a rear electric drive motor for rotating the rear wheels of the vehicle. In either case, the electric drive motors receive power from a battery pack that includes a plurality of battery cells therein. Example battery cells include lithium-ion battery cells and lithium-metal battery cells.

Lithium-ion and lithium-metal battery cells sometimes undergo a process called thermal runaway during failure conditions. Thermal runaway may result in a rapid increase of battery cell temperature accompanied by the release of various gases, which in some cases may be flammable. These flammable gases may be ignited by the high temperature of the battery, which may result in a fire. Accordingly, in the event of a thermal runaway, it is desirable that the vehicle include features that assist in preventing, or at least substantially minimizing, the ignition of various gases that are generated during the thermal runaway.

### SUMMARY

This section provides a general summary of the disclosure, and is not a comprehensive disclosure of its full scope or all of its features.

According to a first aspect of the present disclosure, there is provided a vehicle comprising a battery pack having a housing that encases a plurality of battery cells; a battery thermal management system a coolant inlet line, at least one heat sink configured to receive a coolant from the coolant inlet line and transfer heat generated by the plurality of battery cells to the coolant, and a coolant outlet line configured to receive the coolant from the at least one heat sink; and a battery pack thermal runaway suppression system positioned in the battery pack and including a bladder located proximate the plurality of battery cells that contains a fire-retardant material, a plurality of first blades configured to pierce the bladder to release the fire-retardant material within the housing, a plurality of second blades configured to pierce at least one of the coolant inlet line, heat sink, and coolant outlet line to release the coolant within the housing, and a plurality of actuation devices that are configured to actuate the plurality of first blades and plurality of second blades.

According to the first aspect, the vehicle may further comprise a controller in communication with the plurality of actuation devices.

According to the first aspect, the vehicle may further comprise at least one temperature sensor located in the housing that is configured to generate a signal indicative of a temperature within the housing.

According to the first aspect, the controller is configured to receive and analyze the signal indicative of the temperature within the housing to determine whether to instruct the plurality of actuation devices to actuate the plurality of first blades and the plurality of second blades.

According to the first aspect, the battery thermal management system includes a first pump in fluid communication with the coolant inlet line and configured to be controlled by the controller, and a second pump in fluid communication with the coolant outlet line and configured to be controlled by the controller.

According to the first aspect, after instructing the plurality of actuation devices to actuate the plurality of first blades and the plurality of second blades, the controller is configured to instruct each of the first and second pumps to increase in speed.

According to the first aspect, at least one of the coolant inlet line, the heat sink, and the coolant outlet line includes a plurality of apertures sealed with a plug material that is configured to be pierced by the plurality of second blades.

According to the first aspect, the bladder is formed of a flexible polymeric material, and the flame-retardant material when intermixed with the coolant is configured to generate a foam.

According to a second aspect of the present disclosure, there is provided a thermal runaway suppression method that comprises generating, with a temperature sensor located within a housing of a battery pack, a signal indicative of temperature; determining, based on the signal indicative of temperature, whether a thermal runaway event is occurring or imminent in the battery pack; and after determining that a thermal runaway event is occurring or imminent in the battery pack, communicating an instruction to a plurality of actuation devices to actuate a plurality of first blades to pierce a bladder located within the battery pack that contains a fire-retardant chemical to release the fire-retardant chemical within the battery pack, and actuate a plurality of second blades to pierce a component of a battery thermal management system located within the housing that carries a coolant to release the coolant into the battery pack.

According to the second aspect, the method may further comprise forming a foam by intermixing the fire-retardant chemical released from the bladder and the coolant released from the component of the battery thermal management system.

According to the second aspect, the method may further comprise increasing the speed of a pump that feeds the coolant to the component of the battery thermal management system located in the battery pack.

According to a third aspect of the present disclosure, there is provided a thermal runaway suppression system configured for use in a battery pack having a plurality of battery cells and a thermal management system including a coolant configured for thermal exchange with the plurality of battery cells and at least one temperature sensor for monitoring a temperature of the plurality of battery cells, the thermal runaway suppression system comprising a bladder configured to be located within the battery pack having the plurality of battery cells, the bladder containing a fire-retardant chemical therein; a controller in communication with at least one temperature sensor and configured for receipt of a signal indicative of the temperature of the plurality of battery cells that is generated by the at least one temperature sensor; an actuating device in communication with the controller; and a first blade configured to be moved by the actuating device based on an instruction received by the actuating device from the controller, wherein the first blade is configured to pierce the bladder and release the fire-retardant chemical into the battery pack when moved by the actuating device.

According to the third aspect, the thermal runaway suppression system may further comprise a second blade configured to be moved by the actuating device based on the instructions received by the actuating device from the controller, wherein the second blade is configured to pierce a component of the thermal management system located within the battery pack to release the coolant into the battery pack.

According to the third aspect, the bladder may be formed of a flexible polymeric material.

According to the third aspect, the actuating device may be an electric motor.

According to the third aspect, the component of the thermal management system may be at least one of a coolant inlet line, at least one heat sink configured to receive a coolant from the coolant inlet line and transfer heat generated by the plurality of battery cells to the coolant, and a coolant outlet line configured to receive the coolant from the at least one heat sink.

According to the third aspect, the component includes an aperture that may be sealed with a plug material that is configured to be pierced by the second blade.

According to the third aspect, the coolant may include water and a glycol.

According to the third aspect, the coolant and fire-retardant chemical, when released from the component and bladder and intermixed, are configured to generate a foam.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a vehicle having a thermal runaway suppression system according to a principle of the present disclosure;

FIG. 2 is an isometric perspective view of an example battery pack that may be used in the vehicle illustrated in FIG. 1;

FIG. 3 is rear perspective view of the example battery pack illustrated in FIG. 2;

FIG. 4 is an isometric perspective view of a battery pack thermal management system according to a principle of the present disclosure;

FIG. 5 is a schematic representation of an example battery pack including the battery pack thermal management system illustrated in FIG. 4 and a battery pack thermal runaway suppression system according to a principle of the present disclosure;

FIG. 6A is a schematic perspective view of an example inlet line or outlet line that may be part of each of the battery pack thermal management system and battery pack thermal runaway suppression system;

FIG. 6B is a schematic perspective view of an example heat sink that may be part of each of the battery pack thermal management system and battery pack thermal runaway suppression system; and

FIG. 7 is a flow chart illustrating an example method of operating the battery pack thermal runaway suppression system according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

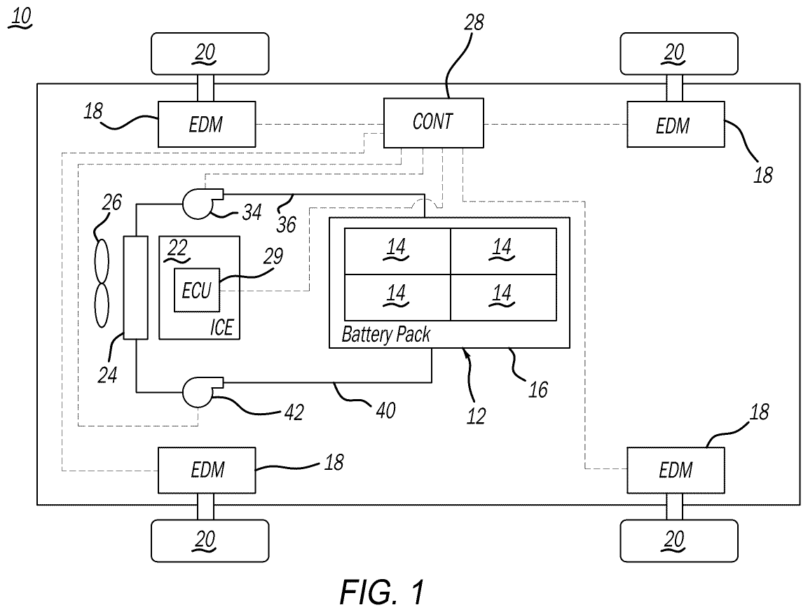

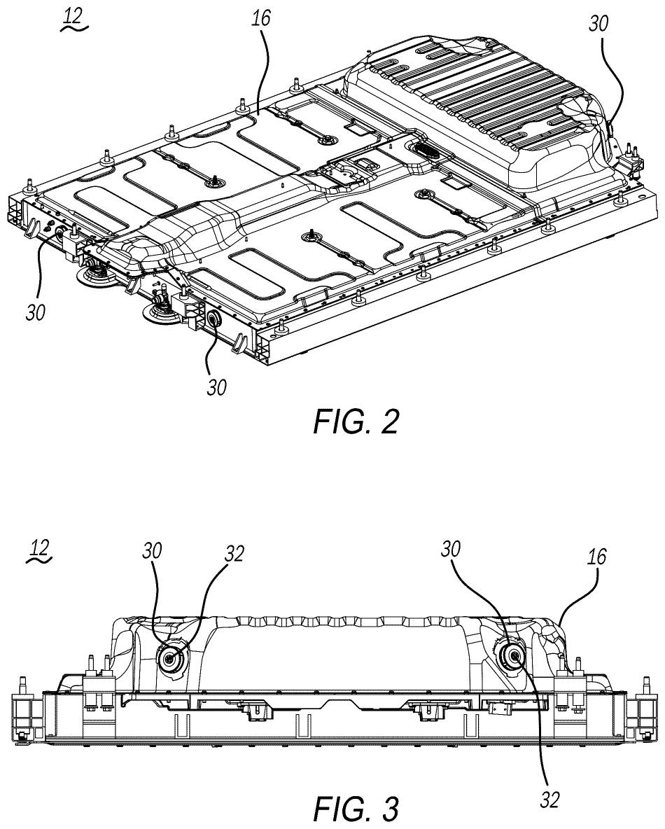

FIG. 1 is a schematic representation of a vehicle 10 according to a principle of the present disclosure. In the illustrated embodiment, vehicle 10 may be an electrically powered vehicle including a battery pack 12 that includes a plurality of battery cells 14. Example battery cells 14 include lithium-ion battery cells, lithium-metal battery cells, and combinations thereof. It should be understood, however, that other types of battery cells 14 known to one skilled in the art may be used, without limitation. Battery pack 12 includes a housing 16 that encases each of the battery cells 14. Housing 16 is preferably formed of a rigid metal material (e.g., steel, aluminum, and the like) that is resistant to puncture and is non-flammable. An example battery pack 12 is illustrated in FIGS. 2 and 3.

Still referring to FIG. 1, a plurality of electric drive modules 18 are illustrated that electrically actuate each wheel 20 of vehicle 10. While four electric drive modules 18 are illustrated, it should be understood that vehicle 10 may include only a pair of electric drive modules 18, or include only a single electric drive module 18. For example, the front wheels 20 of vehicle 10 may be driven by one electric drive module 18, while the rear wheels 20 may be driven by another electric drive module 18. Alternatively, a single electric drive module 18 can be used to drive the pair of front wheels 20 or the pair of rear wheels 20. Regardless of the configuration selected, it should be understood that electric drive modules 18 receive a voltage or current from battery pack 12 that is utilized by the electric drive modules 18 to drive the wheels 20 of the vehicle 10.

While not required, it should also be understood that vehicle 10 may also include an internal combustion engine (ICE) 22 such that vehicle 10 may be a hybrid electric vehicle. In the event that vehicle 10 is a hybrid electric vehicle including ICE 22, a tailpipe (not shown) for carrying exhaust gases generated by ICE 22 may be connected to ICE 22. Vehicle 10 may also include a heat exchanger or radiator 24 and fan 26 for cooling ICE 22 during operation thereof. Vehicle 10 may include a controller 28 that may communicate with battery pack 12, electric drive module(s) 18, and an electronic control unit (ECU) 29 of ICE 20. If vehicle 10 does not include ICE 22, the heat exchanger 24 may be a chiller.

As noted above, battery cells 14 may sometimes undergo a process called thermal runaway during failure conditions of the battery cell(s) 14. Thermal runaway may result in a rapid increase of battery cell temperature accompanied by the release of various gases, which in some cases may be flammable. Example gases that may be released during a thermal runaway event include hydrogen (H₂), carbon monoxide (CO), carbon dioxide (CO₂), and various hydrocarbons including, but not limited to, methane, ethane, ethylene, acetylene, propane, cyclopropane, and butane. As these gases are released and the temperature of battery pack 12 increases, the pressure within battery pack 12 also increases. Housing 16 of battery pack 12, therefore, includes a plurality of vents 30, which are best shown in FIGS. 2 and 3, that permit the pressure and gases to escape housing 16. Vents 30 may each include a valve 32 that may be a one-way valve and opens upon a predetermine pressure threshold being generated within housing 16. For example, if the pressure within housing 16 reaches 100 millibars the valves 32 may open and permit the gases within housing 16 to exit the battery pack 12. Alternatively, valves 32 may be electrically operated (e.g., solenoid) valves that communicate with and can be operated by controller 28.

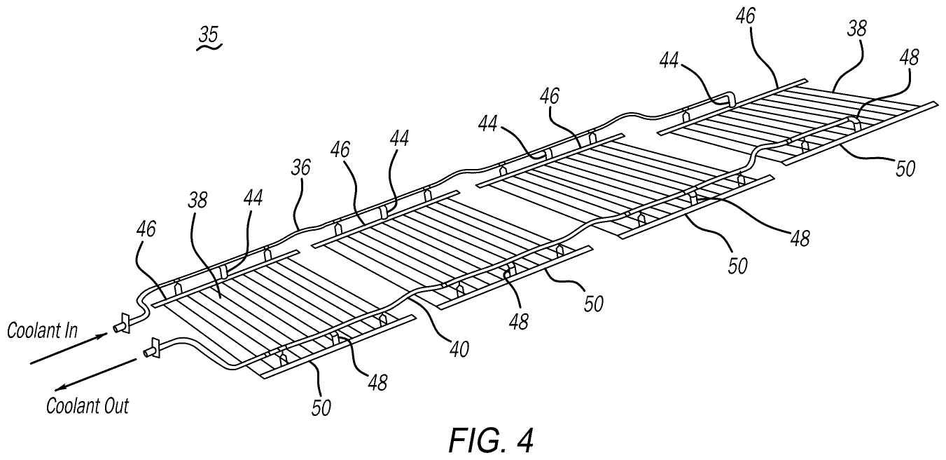

Heat exchanger 24 carries a coolant that can be used to cool battery pack 12 and potentially avoid battery cells 14 from reaching a critical temperature that may lead to thermal runaway. In the illustrated embodiment, the coolant, which may be a mixture of water and glycol, may be drawn to battery pack 12 by a first pump 34 through an inlet line 36. After entering housing 16, coolant can pass through heat sinks 38 (FIG. 4) in thermal contact with battery cells 14 that draw heat away from battery cells 14 to be exchanged with the coolant such that the coolant will absorb heat generated by batteries 14 before exiting housing 16 through an outlet line 40. Coolant in outlet line 40 can be drawn back to heat exchanger 24 by a second pump 42 where the coolant can exchange the heat absorbed from the batteries 14 with the ambient air passing through heat exchanger 24 that is drawn by fan 26 until the process starts again.

FIG. 4 illustrates an example arrangement of the inlet line 36, heat sinks 38, and outlet line 40 within housing 16 (not shown in FIG. 4) of battery pack 12. Put another way, FIG. 4 illustrates an example battery thermal management system 35. As can be seen in FIG. 4, inlet line 36 may extend along a length of battery pack 12 and includes a plurality of inlet branches 44 that respectively feed coolant from inlet line 26 to a plurality of inlet manifolds 46. Similarly, outlet line 40 may extend along the length of battery pack 12 and includes a plurality of outlet branches 48 that respectively receive coolant from a plurality of outlet manifolds 50. Inlet manifolds 46 and outlet manifolds 50 are each in communication with a plurality of heat sinks 38.

Coolant carried by inlet line 36 flows from inlet line 36 into inlet branches 44, then flows from inlet branches 44 into inlet manifolds 46, and then flows from inlet manifolds 46 into the plurality of heat sinks 38 where heat generated by battery cells 14 (not shown in FIG. 4) that lay overtop heat sinks 38 is exchanged with the coolant therein. Coolant that has exchanged heat with battery cells 14 flows from heat sinks 38 into outlet manifolds 50, then flows from outlet manifolds 50 into outlet branches 48, and then flows from outlet branches 48 into outlet line 40, which carries the coolant back to heat exchanger 24 to be cooled by the ambient air drawn by fan 26. As this process repeats, battery cells 14 may be cooled to maintain battery cells 14 beneath a critical temperature that can lead to thermal runaway.

It should be understood that cooling of battery cells 14 may be controlled by controller 28. In this regard, again referring to FIG. 1, it should be understood that battery pack 12 includes at least one temperature sensor 52 in communication with battery pack 12 that generates signals indicative of temperature within battery pack 12. While only a single temperature sensor 52 is illustrated in FIG. 1, it should be understood that a plurality of temperature sensors 52 may be used. For example, each battery cell 14 may include a dedicated temperature sensor 52 such that a temperature of each individual battery cell 14 may be monitored and communicated to controller 28.

Controller 28 can adjust an amount of coolant that is circulated through battery thermal management system 35 based on the signal(s) indicative of temperature generated by temperature sensors 52 that are received by controller 28. For example, if controller 28 determines, based on the signals indicative of temperature generated by temperature sensor(s) 52, that battery cells 14 are operating at a temperature that requires increased cooling, controller 28 can instruct pumps 34 and 42 to increase in speed to reduce the amount of time that it takes the coolant to circulate through battery thermal management system 35. Similarly, if controller 28 determines, based on the signals indicative of temperature generated by temperature sensor(s) 52, that battery cells 14 are not operating at a temperature that requires increased cooling, controller 28 may adjust the speed of pumps 34 and 42 accordingly.

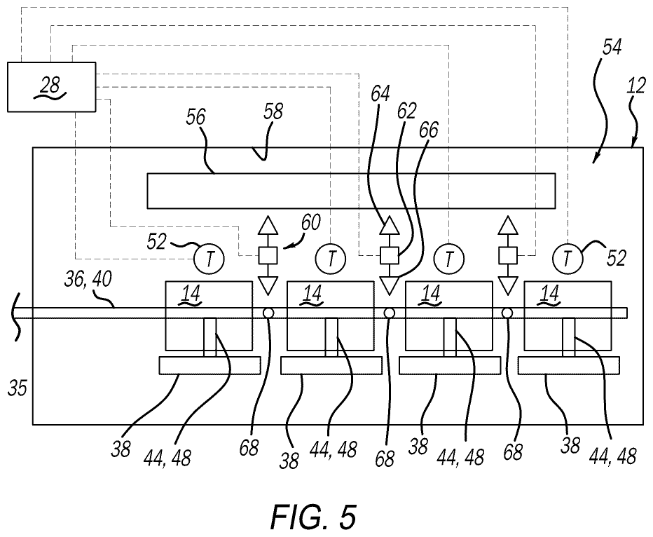

While battery thermal management system 35 is configured to actively monitor a temperature of battery cells 14, it should be understood that battery thermal management system 35 by itself may not be sufficient to stop or mitigate a thermal runaway event. Accordingly, the present disclosure provides a battery pack 12 having a thermal runaway suppression system 54 (FIG. 5) that operates in conjunction with battery thermal management system 35. As shown in FIG. 5, thermal runaway suppression system 54 is located within housing 16 of battery pack 12 and includes a bladder 56 that is filled with a flame-retardant chemical. An example flame-retardant chemical is a fluorine-free, low viscosity aviation foam sold under the tradename Solberg Avigard™. Other materials known to one skilled in the art, however, are contemplated. Bladder 56 may be positioned between battery cells 14 and an upper surface 58 of housing 16, and may be formed of a flexible material such as a polymeric material (e.g., silicone) that can be punctured to release the flame-retardant chemical as will be described in more detail later.

Thermal runaway suppression system 54 also includes a plurality of puncturing devices 60 that include an actuator 62, a first blade 64 that is configured to puncture bladder 56, and a second blade 66 that is configured to puncture the inlet line 36 and outlet line 40 of battery thermal management system 35. As noted above, the coolant utilized by battery thermal management system 35 contains a mixture of water and glycol. When the coolant is released from inlet line 36 and outlet line 40 after puncturing, the coolant intermixes with the flame-retardant chemical that is released by bladder 56 and a flame-retardant foam is created that is configured to prevent formation of flames, or extinguish any existing flames, that may occur during thermal runaway.

As shown in FIG. 5, each actuator device 62 is in communication with controller 28 and a plurality of temperature sensors 52 are in communication with controller 28 for communicating signals indicative of temperature within battery pack 12. Based on signals indictive of temperature communicated by temperature sensors 52 to controller 28, controller 28 can determine whether a battery cell 14 or multiple battery cells 14 may be reaching a critical temperature where a thermal runaway event may occur. If controller 28 determines that a thermal runaway is occurring or at least likely to occur, controller 28 can instruct actuator 62 to move first and second blades 64 and 66 in directions toward bladder 56 and inlet and outlet lines 36, 40, respectively, to puncture these features and release the fire retardant chemicals stored in bladder 56 and release the coolant passing through inlet and outlet lines 36, 40 so that these materials are sprayed over battery cells 14, intermix, and create the fire-retardant foam.

Actuator devices 62 may include electric motors such as, for example, solenoid-operated motors that can drive the first and second blades 64 and 66 in directions toward the bladder 56 and inlet and outlet lines 36, 40, respectively. Alternatively, first and second blades 64 and 66 may be spring-loaded cutting devices, and the actuator device 62, which may be configured to displace a locking device (not shown) that retains the springs (not shown) in a compressed state.

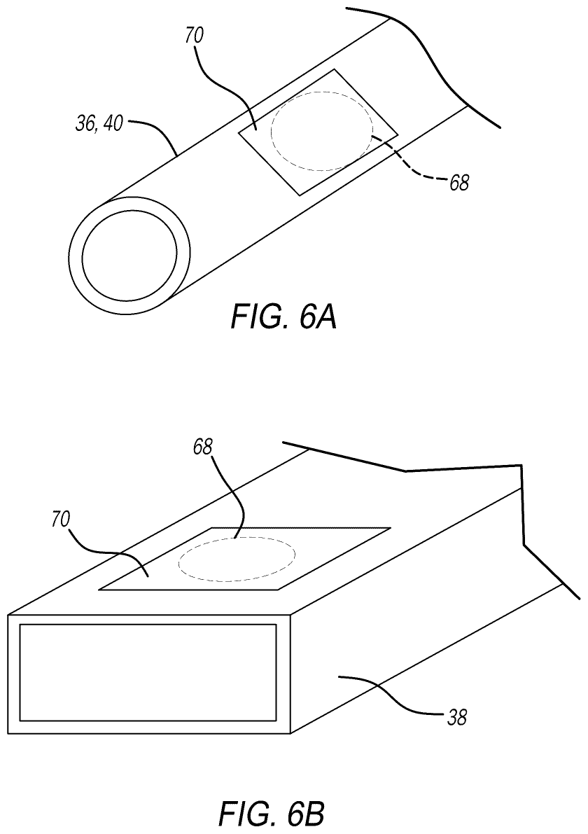

It should be understood that inlet and outlet lines 36 and 40 are generally formed from a rigid and corrosion-resistant material such as copper, aluminum, or some other type of rigid metal material. It can be difficult, therefore, to puncture the inlet and outlet lines 36 and 40 with second blades 66. Accordingly, as best shown in FIG. 6A, inlet and outlet lines 36 and 40 may be manufactured (or modified if the battery pack 12 is being retrofit to include to include bladder 56, actuators 62, and blades 64, 66) to include a plurality of apertures 68 at locations that correspond to locations of second blades 66. After manufacturing or modifying inlet and outlet lines 36 and 50 to include apertures 68, the apertures 68 can then be filled or covered with a plug material 70 that may be, for example, a silicone or some other type of polymeric material that can easily be punctured by second blades 66. The material selected for plug material 70 should be able to withstand fluctuations in pressure experienced by inlet and outlet lines 36 and 40 as pumps 34 and 42 modify the flow of coolant through battery thermal management system 35.

While second blades 66 have been described as being configured to puncture inlet and outlet lines 36 and 40, it should be understood that second blades 66 can alternatively be designed to puncture heat sinks 38. Heat sinks 38 may be formed of materials that are similar to inlet and outlet lines 36 and 40. That is, heat sinks 38 may be formed of a rigid metal material such as copper, aluminum or some other type of material that is thermally conductive. Heat sinks 38, therefore, may be manufactured or modified (if battery pack 12 is being retro-fitted to include thermal runaway suppression system 54) to include apertures 68 that are filled or covered with the plug material 70 that is easily pierceable by second blades 66 (FIG. 6B).

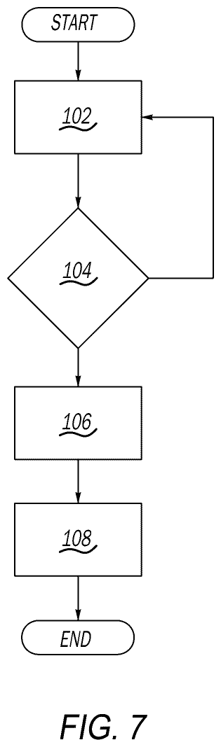

Now referring to FIG. 7, a method 100 of operating battery thermal runaway suppression system 54 will be described. At step 102, controller 28 receives signals indicative of temperature from temperature sensors 52. After receipt of the signals indicative of temperature, controller 28 analyzes the signals to determine whether any signals are indicative of a thermal runaway event (step 104). If no signals are indicative of a thermal runaway event, the method may return to step 102. If controller 28 determines that a thermal runaway event may be occurring or potentially imminent, the method may proceed to step 106 where controller 28 communicates a signal to actuator devices 62 to actuate first and second blades 64 and 66 to puncture bladder 56 and inlet/outlet lines 36 and 40 in order to release the flame-retardant chemical and coolant carried therein, respectively. The method may also include an optional step 108 that is conducted after actuator devices 62 have actuated the first and second blades 64 and 66, where controller 28 communicates a signal to pumps 34 and 42 to increase in speed in order to pump coolant through inlet and outlet lines 36 and 40 at a greater rate, which may increase the amount of coolant that is released through apertures 68 after puncturing plug 70. Increasing the amount of coolant released through apertures 68 may assist in intermixing of the coolant with the fire-retardant chemical released by puncturing bladder to form the fire-retardant foam, and reduce or mitigate the effects of thermal runaway.

Lastly, it should be understood that valves 32 that are located in vents 30 (FIG. 3) may be electrically operated valves that can be controlled by controller 28. During a thermal runaway event, it may be preferable to open valves 32 using controller 28 and permit any pressure build-up in housing 16 to be released. Opening of valves 32, however, may also permit the foam generated by intermixing of the coolant and fire-retardant chemical to escape housing 16. It may be desirable, therefore, to pulse valves 32 in an effort to release pressure while simultaneously attempting to maintain the foam within housing 16 during suppression of the thermal runaway event.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a battery pack having a housing that encases a plurality of battery cells;
a battery thermal management system a coolant inlet line, at least one heat sink configured to receive a coolant from the coolant inlet line and transfer heat generated by the plurality of battery cells to the coolant, and a coolant outlet line configured to receive the coolant from the at least one heat sink; and
a battery pack thermal runaway suppression system positioned in the battery pack and including a bladder located proximate the plurality of battery cells that contains a fire-retardant material, a plurality of first blades configured to pierce the bladder to release the fire-retardant material within the housing, a plurality of second blades configured to pierce at least one of the coolant inlet line, heat sink, and coolant outlet line to release the coolant within the housing, and a plurality of actuation devices that are configured to actuate the plurality of first blades and plurality of second blades.

2. The vehicle according to claim 1, further comprising a controller in communication with the plurality of actuation devices.

3. The vehicle according to claim 2, further comprising at least one temperature sensor located in the housing that is configured to generate a signal indicative of a temperature within the housing.

4. The vehicle according to claim 3, wherein the controller is configured to receive and analyze the signal indicative of the temperature within the housing to determine whether to instruct the plurality of actuation devices to actuate the plurality of first blades and the plurality of second blades.

5. The vehicle according to claim 2, wherein the battery thermal management system includes a first pump in fluid communication with the coolant inlet line and configured to be controlled by the controller, and a second pump in fluid communication with the coolant outlet line and configured to be controlled by the controller.

6. The vehicle according to claim 5, wherein after instructing the plurality of actuation devices to actuate the plurality of first blades and the plurality of second blades, the controller is configured to instruct each of the first and second pumps to increase in speed.

7. The vehicle according to claim 1, wherein at least one of the coolant inlet line, the heat sink, and the coolant outlet line includes a plurality of apertures sealed with a plug material that is configured to be pierced by the plurality of second blades.

8. The vehicle according to claim 1, wherein the bladder is formed of a flexible polymeric material, and the flame-retardant material when intermixed with the coolant is configured to generate a foam.

9. A thermal runaway suppression method comprising:
generating, with a temperature sensor located within a housing of a battery pack, a signal indicative of temperature;
determining, based on the signal indicative of temperature, whether a thermal runaway event is occurring or imminent in the battery pack;
after determining that a thermal runaway event is occurring or imminent in the battery pack, communicating an instruction to a plurality of actuation devices to actuate a plurality of first blades to pierce a bladder located within the battery pack that contains a fire-retardant chemical to release the fire-retardant chemical within the battery pack, and actuate a plurality of second blades to pierce a component of a battery thermal management system located within the housing that carries a coolant to release the coolant into the battery pack.

10. The method according to claim 9, further comprising forming a foam by intermixing the fire-retardant chemical released from the bladder and the coolant released from the component of the battery thermal management system.

11. The method according to claim 9, further comprising increasing the speed of a pump that feeds the coolant to the component of the battery thermal management system located in the battery pack.

12. A thermal runaway suppression system configured for use in a battery pack having a plurality of battery cells and a thermal management system including a coolant configured for thermal exchange with the plurality of battery cells and at least one temperature sensor for monitoring a temperature of the plurality of battery cells, the thermal runaway suppression system comprising:
a bladder configured to be located within the battery pack having the plurality of battery cells, the bladder containing a fire-retardant chemical therein;
a controller in communication with at least one temperature sensor and configured for receipt of a signal indicative of the temperature of the plurality of battery cells that is generated by the at least one temperature sensor;
an actuating device in communication with the controller; and
a first blade configured to be moved by the actuating device based on an instruction received by the actuating device from the controller, wherein the first blade is configured to pierce the bladder and release the fire-retardant chemical into the battery pack when moved by the actuating device.

13. The thermal runaway suppression system according to claim 12, further comprising a second blade configured to be moved by the actuating device based on the instructions received by the actuating device from the controller, wherein the second blade is configured to pierce a component of the thermal management system located within the battery pack to release the coolant into the battery pack.

14. The thermal runaway suppression system according to claim 13, wherein the bladder is formed of a flexible polymeric material.

15. The thermal runaway suppression system according to claim 13, wherein the actuating device is an electric motor.

16. The thermal runaway suppression system according to claim 13, wherein the component of the thermal management system is at least one of a coolant inlet line, at least one heat sink configured to receive a coolant from the coolant inlet line and transfer heat generated by the plurality of battery cells to the coolant, and a coolant outlet line configured to receive the coolant from the at least one heat sink.

17. The thermal runaway suppression system according to claim 16, wherein the component includes an aperture that is sealed with a plug material that is configured to be pierced by the second blade.

18. The thermal runaway suppression system according to claim 13, wherein the coolant includes water and a glycol.

19. The thermal runaway suppression system according to claim 18, wherein the coolant and fire-retardant chemical, when released from the component and bladder and intermixed, are configured to generate a foam.
